(19) United States
(12) Patent Application Publication
(10) Pub. No.: US 2026/0038484 A1
(43) Pub. Date: Feb. 5, 2026

(54) SYSTEMS AND METHODS FOR AUDIO-BASED CONTENT RECOGNITION

(71) Applicant: VIZIO, INC., Irvine, CA (US)

(72) Inventors: Dave Witonsky, Littleton, CO (US); Michael Imberman, McKinney, TX (US)

(73) Assignee: VIZIO, INC., Irvine, CA (US)

(21) Appl. No.: 19/288,108

(22) Filed: Aug. 1, 2025

Related U.S. Application Data
(60) Provisional application No. 63/678,643, filed on Aug. 2, 2024.

(51) Int. Cl. G10L 15/10; G06F 16/635; G10L 15/16; G10L 15/22; G10L 15/30

(52) U.S. Cl. CPC G10L 15/10; G06F 16/635; G10L 15/16; G10L 15/22; G10L 15/30; G10L 2015/223

(57) ABSTRACT

An automated content recognition system can identify media presented by a media device using an audio channel of the media. The media device may isolate an audio segment from the audio channel of the media. A speech-to-text model may be executed using the audio segment to identify a sequence of words represented by the audio segment. The media device may transmit an unknown audio including the sequence of words to an ACR server. The ACR server may compare the sequence of words of the unknown audio cue to words of reference audio cues associated with known media segments. Upon identifying a reference audio cue that matches the unknown audio cue, the ACR server may cause the media device to execute one or more commands based on an identifier of the matching reference audio cue

### CROSS-REFERENCE TO RELATED APPLICATIONS

The present patent application claims the benefit of priority to U.S. Provisional Patent Application No. 63/678,643 filed Aug. 2, 2024 and is related to U.S. Patent Application entitled “SYSTEMS AND METHODS FOR TEXT-BASED CONTENT RECOGNITION” (Attorney Docket No. 095130-843026-004400US) filed Aug. 1, 2025, which are both incorporated herein by reference in their entirety for all purposes.

### TECHNICAL FIELD

This disclosure relates generally to identifying media, and more particularly to machine-learning processes for isolating and processing audio channels for content recognition.

### BACKGROUND

Advancements in fiber optic and digital transmission technology have enabled the television industry to rapidly increase channel capacity and, hence, to provide hundreds of channels of television program in addition to thousands or more channels of on-demand programming. In addition to the increased channel capacity, the proliferation of internet-connected televisions and smart televisions have increased access to streaming services and other network-accessible programming. Some televisions may provide functions that augment or improve a presentation of particular programming (e.g., such as interactive television (ITV), contextual browsing, purchasing, searching, etc.). With the increased quantity of programming and programming sources, televisions may not be able to detect what particular programming is being presented preventing the televisions from providing the functions.

### SUMMARY

Methods are described herein for machine-learning processes for isolating and processing audio channels for content recognition. Some methods may include receiving an audio cue including a representation of an audio channel of an unknown media segment being presented by a media device; searching a known media database using a set of words of the audio cue, wherein the known media database stores reference audio cues associated with known media segments, and wherein searching the known media database includes comparing the set of words of the audio cue with words of reference audio cues; identifying a particular known media segment from the known media database associated with a known audio cue that at least partially matches the audio cue of the unknown media segment; and executing an event in response to identifying the unknown media segment.

Other methods may include isolating an audio segment of an unknown media segment, wherein the unknown media segment is being presented by a media device; generating an audio cue including a representation of the audio segment; transmitting the audio cue to a media server, wherein the media server is configured to identify the unknown media segment being presented by the media device using the audio cue; receiving a response including an identification of the unknown media segment; and presenting, by the media device, an alternative media segment in response to receiving the identification of the unknown media segment.

Systems are described herein for machine-learning processes for isolating and processing audio channels for content recognition. The systems may include one or more processors and a non-transitory computer-readable medium storing instructions that, when executed by the one or more processors, cause the one or more processors to perform any of the methods as previously described.

Non-transitory computer-readable media are described herein for storing instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of an example media device configured to process an audio channel of media automated content recognition according to aspects of the present disclosure.

FIG. 2 illustrates a block diagram of an example ACR server configured to process an audio channel of media automated content recognition according to aspects of the present disclosure.

FIG. 3 illustrates a block diagram of an example automated content recognition system configured to identify media segments using an audio channel according to aspects of the present disclosure.

FIG. 4 illustrates a block diagram of an example automated content recognition system with cloud-based load balancing according to aspects of the present disclosure.

FIG. 5 illustrates a block diagram of an example automated content recognition system with enhanced local processing according to aspects of the present disclosure.

FIG. 6 illustrates a flowchart of an example process of a media device processing an audio component of media to identify a media segment of the media according to aspects of the present disclosure.

FIG. 7 illustrates a flowchart of an example process of a automate content recognition system configured to process audio cues to identify media segments and manage media device based on identified media segments according to aspects of the present disclosure.

FIG. 8 illustrates an example computing device architecture of an example computing device that can implement the various techniques described herein according to aspects of the present disclosure.

### DETAILED DESCRIPTION

Methods and systems are presented herein for automated content identification, including machine-learning processes for isolating and processing audio channels for content recognition. Automated content recognition (ACR) systems may be implemented by media devices and/or servers. In some instances, ACR systems may enable execution of particular functions of media devices. For example, once a media segment is identified, the media device may provide additional information about the media segment (e.g., such as an identification of the actors, production personnel, settings, etc.), generate an on-demand version of the media segment (e.g., such as a version without advertisements or with alternative advertisements, etc.), identify candidate media segments for content substitution, provide access to information associated with media segment (e.g., such as website, etc.), establish connections to remote devices, combinations thereof, and/or the like.

An automated content recognition ACR system may use an audio channel and/or a video channel of a media segment to identify the media segment. A video ACR process may generate a video cue from one or more sets of pixels of a video frame of an unknown media segment. The video ACR process may then compare the video cue of the unknown media segment to video cues of known media segments to identify the unknown media segment. An audio ACR processes may generate an audio cue from the audio channel of the unknown media segment. In some examples, the audio cue may include words identified from the audio channel. The words may be identified using a speech-to-text model such as a machine-learning model or other model configured to extract features from an audio segment and identify one or more words in the audio segment using the features. In other examples, the audio cue may include features extracted from the audio channel such as, but not limited to, mel-frequency cepstrum coefficients, processed or unprocessed segments of analog audio, processed or unprocessed segments of digital audio, words extracted from a speech-to-text model, combinations thereof, and/or the like. The audio ACR process may then compare the audio cue of the unknown media segment to audio cues of known media segments to identify the unknown media segment.

A media device (e.g., such as, but not limited to, televisions, monitors, computing devices, etc.) may be configured to present media from a variety of sources such as broadcast television, cable television, stream services, on-demand services, the Internet, etc. The media device may communicate with a server (e.g., content delivery network, cloud network, etc.) to identify particular media segments being presented by the media device. The media device may be configured to generate an audio cue from the media segment that is being presented. In some examples, the audio cue may include a representation of the audio channel of the media segment. For example, if the media device lacks the processing resources to fully process audio, then the cue may include audio segments extracted from the audio channel. The media device may transmit the cue to the server and the server may process the audio segment for an ACR process. In other examples, such when the media device includes sufficient processing resources, the media device may process the audio channel to generate a set of features. The media device may then generate a cue using the set of features.

For example, the media device may include a speech-to-text model configured to extract words from the audio channel. The speech-to-text model may include one or more processes and/or machine-learning models that identify words from an audio input. For instance, the speech-to-text model may preprocess the audio segment by applying one or more filters reduce or eliminate frequencies that are likely to be outside frequencies of speech. Frequencies associated with human voices are typically between 250 Hertz and 4000 Hertz. The media device may filter out frequencies of the audio segment outside of the voice frequency range of 250 Hz to 4000 Hz. The media device may expand the voice frequency range by a predetermined amount to avoid removing portions of the audio segment that may correspond to speech. The speech-to-text model may use the filters to identify pauses representing spaces between words and parse the audio segment to in a set of filtered audio samples with each audio sample representing a word of the audio segment. The speech-to-text model may execute other preprocessing steps such as, but not limited to, frequency modulation (e.g., to increase or reduce an intensity of frequencies, normalization, translation (e.g., analog-to-digital, digital-to-analog, etc.), combinations thereof, and/or the like.

The speech-to-text model may use pattern matching and/or an acoustic model to classify the phonemes of each filtered audio sample. The phonemes may be aggregated into a sequence of phonemes representing a word. The speech-to-text model may then match the sequence of phonemes to known phonetic patterns (e.g., sequence of phonemes associated with a known word). Phonetic patterns may be stored in the database in association with a known word or phrase. If filtered audio sample is incomplete or does not match a known phonetic pattern, the speech-to-text model may apply a probabilistic model to determine one or more phonemes that are most likely to follow the phonemes of the incomplete, filtered audio sample. For instance, the speech-to-text model may use a Hidden Markov Model or the like. The probabilistic model may also be used when classifying the filtered audio samples to reduce a likelihood of error or false positives.

Alternatively, or additionally, the speech-to-text model may be or include a machine-learning model trained to classify the filtered audio samples, the filtered audio segment, and/or the audio segment (e.g., without preprocessing the audio segment). The machine-learning model may be a neural network, such as, but not limited to, a recurrent neural network (e.g., a long-short term memory, mask recurrent neural network, etc.), gated recurrent unit(s) (GRU), a convolutional neural network, a deep learning network, a transformer (e.g., such as an encoder representations from transformers, generative pretrained transformer, etc.), an adversarial network, combinations thereof, and/or the like.

The machine-learning model may be trained using supervised learning, unsupervised learning, semi-supervised learning, transfer learning, metalearning, reinforcement learning, combinations thereof, or the like using a training dataset derived from media including an audio channel (e.g., such as, but not limited to, television, sports programming, movies, advertisements, songs, combinations thereof, and/or the like). If the training dataset is smaller than a threshold (e.g., the quantity of representations of media is not greater than the threshold, the quantity of representations of particular types of media is not greater than the threshold, etc.), then the training dataset may be augmented with additional data corresponding to the media or type of media that that is less than the threshold. The additional data may include manually generated data associated with the media or type of media, data associated with similar media or types of media, procedurally generated data associated with the media or type of media, combinations thereof, and/or the like. In some instances, such as when the machine-learning model is to be training using supervised learning techniques, labels may be added to the training dataset. The labels may be generated manually (e.g., via user input, etc.), by an already training instance of the machine-learning model, by a generative adversarial network, combinations thereof, and/or the like. The machine-learning model may be trained over a predetermined time interval, for predetermined quantity of iterations, and/or until one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like.

In some examples, the speech-to-text model may be executed by the media device to generate a sequence of words that appear in the audio segment. The media device may generate a cue that includes the sequence of words. The cue may also include metadata such as, but not limited to, an identification of the media device, a hardware and/or software profile of the media device (e.g., such as an identification hardware and/or software installed on the media device and/or version identifiers, serial numbers, model numbers, etc. of the installed hardware and/or software, etc.), a network profile of the media device (e.g., an Internet Protocol address, a Media Access Control address, etc.), an identification of the state of the media device's processing resources (e.g., central processing unit load, memory utilization, bandwidth utilization, etc.), combinations thereof, and/or the like. The media device may transmit the cue to an ACR server to identify the media segment that corresponds to the cue.

In other examples, such as when the media device lacks the processing resources to execute the speech-to-text model (e.g., based on hardware and/or software installed on the device and/or based on a current state of the available processing resources of the media device, etc.), the media device may generate a cue that corresponds to a preprocessed and/or unprocessed representation of the audio segment. Upon being received by the ACR server, a speech-to-text model of the ACR server (similar to the speech-to-text model previous described), may execute to identify the sequence of words of the audio segment. The media device may determine, a runtime, whether to execute the speech-to-text model or to transmit the (preprocessed or unprocessed) audio segment to the ACR server.

The ACR server may include or have access to a database of buckets corresponding to known media. Each bucket may store a set of words that are associated with known media. The set of words may be unordered, ordered (e.g., in which the words or ordered in a same or similar sequences as the words appear in the known media, or partially ordered (e.g., include some sequences, etc.). The ACR server may compare the sequence of words to the buckets to identify the bucket that is a closest match to the sequence of words (e.g., based on a quantity of words of the sequence of words that match words of the bucket, the sequence of the sequence of words appearing matching the sequence of words from the bucket, combinations thereof, and/or the like. The ACR server may determine that the media of the media device (from which the cue was derived) corresponds to the known media associated with the closest matching bucket. The ACR server may also determine an offset corresponding to timestamp of the current portion of the media that is being presented by the media device.

The ACR server may transmit the identification of the media associated with cue to the media device. The media device may execute one or more functions based on the identification of the media. For instance, the media device may present information associated with the media (e.g., such as an identification of product or services appearing in the media, links to the products and/or services, information associated with actors appearing in the media, information associated with production personnel (e.g., such as, but not limited to, directors, producers, etc.), information associated with settings and/or filming locations, facts about the media, combinations thereof, and/or the like), execute content substitution (e.g., replace the media or a portion of the such as an advertisement, with a substitute media or media segment), execute content insertion (e.g., insert a media segment into the media at a particular time interval), execute content removal (e.g., remove a media segment from the media such as an advertisement, etc.), combinations thereof, and/or the like. In instances, the ACR server may transmit commands to the media device to cause the media device to execute any of the one or more functions.

The ACR server may also transmit the identification of the media associated with the cuc to an attribution server. An attribution server may store information on what media is presented by media devices (e.g., such as what channels, television shows, commercials and/or advertisements, etc.) based on the information received from the ACR server. The attribution server may generate reports and/or perform statistical modeling based on the media being presented by media devices. The reports and/or statistical modeling may be used to modify the media being presented at particular media devices (e.g., selected based on location of the media devices, demographic information associated with the media devices, media presented by the media devices, etc.).

In an illustrative example, a computing device may receive an audio cue including a representation of an audio channel of an unknown media segment being presented by a media device. The media segment may include an audio segment (e.g., from an audio channel of the media) that includes an audible representation of words (e.g., such as, but not limited to, one or more characters speaking, a song, a narrator, etc.). Media devices may generate an audio including features derived from the audio channel of the media. Media devices may transmit the audio cues to the computing device (e.g., personal computer, server, cloud network, content delivery network (CDN), and/or the like to identify media that is being presented by the media devices, receive commands from the computing device based on the identification of media being presented by media devices, generate reports of media being presented by media devices, combinations thereof, and/or the like.

In some examples, the features of the audio cue may include a set of words extracted from the audio channel of the media. For instance, the media device may include a speech-to-text model that may identify words within the audio channel. Alternatively, the media device may transmit an audio sample to a remote device and the remote device may return an identification of the set of words represented in the audio sample. The media device may generate an audio cue including one or more words (in an ordered sequence or as an unordered collection) and transmit the audio cue to the computing device to identify the media. In other examples, the media device may be unable to process the audio channel to extract the set of words. For instance, the media device may lack the processing resources, be under a heavy processing load, etc. In those examples, the features of the audio cue may include a representation of an audio segment of the audio channel (e.g., processed or unprocessed audio). The computing device may extract the words from the audio segment using a speech-to-text model. The speech-to-text model may be similar to the speech-to-text model utilized by the media device (e.g., of a same type, trained using similar or the same data, etc.). Alternatively, the computing device may transmit the audio cue to a remote device configured to identify the set of words. The remote device may process the audio cue and return an identification of the set of words.

The computing device may search a known media database using the set of words of the audio cue. The known media database may store reference audio cues associated with known media segments. The reference audio cues may include one or more sets of words extracted from the known media segments. The one or more sets of words may include sequences of words and/or collections of words (e.g., unordered). The computing device may compare the set of words and/or one or more subsets of the sets of words to the reference audio cues of the known media database. In some instances, the computing device may use an exact match algorithm to identify reference audio cues that exactly match a predetermined quantity of words of the audio cue. For instance, the computing device may identify reference audio cues that include the set of words in the same order. Alternatively, the computing device may identify reference audio cues that include at least a particular subset of the set of words. The computing device may determine a minimum quantity of words that must be included within a predetermined quantity of words of a reference audio cue for the reference audio cue to be considered a match to the audio cue of the unknown media segment. The minimum quantity of words may be selected to increase the accuracy of searching the known media database (e.g., by increasing the minimum quantity of words that must match) and/or to increase the speed in which matches may be identified (e.g., by decreasing the minimum quantity of words that must match). The minimum quantity of words (and/or the predetermined quantity of words) may be dynamically selected to increase the accuracy of searching the known media database (e.g., by increasing the minimum quantity of words that must match) and/or increase the speed in which matches may be identified (e.g., by decreasing the minimum quantity of words that must match).

In other instances, the computing device may use a closest match algorithm when searching the known media database. The closest match algorithm may identify one or more reference audio cues of the known media database that include words that match the set of words of the unknown media segment in the same general order. The closest match algorithm may then assign a score to each of the one or more reference audio cues based on a degree in which the reference audio cue matches the set of words in a same order. The computing device may select the reference audio cue assigned the highest score as the reference audio cue that is a closest match to the audio cue.

The closest match algorithm may identify a matching reference audio cue even when the complete sequence of words of the set of words of the unknown media segment is not included in the reference audio cue. For example, the audio cue may be missing one or more words due to errors, poor speech-to-text translations, data corruption, etc. The closest match algorithm may use a scoring system to enable identify reference audio cues that match even when the audio cue may not be accurate or may be incomplete. The closest match algorithm may assign score based on the quantity of the reference audio cue that match the audio cue in the same order. The closest match algorithm may lower the score for each intervening words (e.g., words of the reference audio cue positioned between words the audio cue and not included in the audio cue). For example, the audio cue may include the word sequence “the quick brown fox over the lazy dog”. The candidate reference audio cue “the quick brown fox jumps over the lazy dog” may include all of the words of the audio cue in the same order but includes the intervening word “jump”. The closest match algorithm may assign “1” for each matching word in the correct order and subtract 0.5 for each intervening word causing the candidate reference audio to be assigned a score of 7.5. If the closest match algorithm may does not assign another reference audio cue with a higher score, then the candidate reference audio may be considered a match for the audio cue.

In still yet other instances, the computing device may use an approximate string matching algorithm (e.g., such as a fuzzy string search, etc.). Approximate string matching algorithms may identify strings (e.g., one or more words, phrases, sentences, etc.) that are an approximate match to the set of words of the unknown media segment. For example, approximate string matching algorithms may identify the word “jumps” from an input of “jump” even though the input word does not exactly match the identified word. Approximate string matching algorithms may reduce a likelihood of errors (e.g., caused by the speech-to-text model, transmission, etc.) from impacting the ability of the computing device to identify a matching reference audio cue.

Other matching algorithms may be used in addition to or in place of exact match, closest match, and/or an approximate string matching such as, but not limited to a distance search, interpolation searching, etc.

In some examples, the computing device may dynamically switch between exact match, closest match, and approximate string matching algorithms based on a current state of the computing device and/or the media device requesting automated content recognition services. For example, the computing device may default to an exact match and switch to closest match or approximate string matching algorithms upon determining that the exact match has timed out (e.g., takes too long to identify a matching reference audio cue or cannot identify a reference audio cue, etc.) or when a processing load of the computing device is greater than a threshold load value.

The computing device may identify a particular reference audio cue that matches the audio cue. The computing device may assign an identifier of the known media segment associated with the particular reference audio cue to the unknown media segment.

The computing device may then execute an event in response to identifying particular reference audio cue that matches the audio cue. In some instances, the event may include transmitting a communication to the media device. The communication may include a command that, when executed by the media device, causes the media device to perform one or more operations such as, but not limited to, presenting an alternative media segment in place of the (now) known media segment being presented by the media device, presenting an alternative media segment in place of a future media segment that is scheduled to be presented by the media device, present additional information associated with the (now) known media segment being presented by the media device, presenting information associated with an object or service depicted in the (now) known media segment being presented the media device (e.g., via a web browser or application of the media device), facilitating a presentation of any of the aforementioned media and/or information on another device associated with the media device (e.g., such as a mobile device, tablet, computing device, etc. in communication with the media device), combinations thereof, and/or the like. Alternatively, or additionally, the event may include transmitting a communication to another remote device to cause a watermark to be embedded into a media being presented by the media device (e.g., such as a watermark, etc.) configured to cause the media device to execute one or more functions, report an identification of the unknown media segment, request media that is contextually related to the (now) known media segment, combinations thereof, and/or the like.

In another illustrative example, a media device may request automated content recognition services from a computing device. The media device may isolate an audio segment of an unknown media segment that is being presented by the media device. The audio segment may correspond to a portion of audio presented via the audio channel. In some examples, the media device may define one or more audio segments by sampling the audio channel according to a sampling rate value. The sampling rate value may determine a quantity of samples that define from the audio channel over a predetermined time interval. In some instances, the audio segments may be non-overlapping (e.g., each audio segment is derived from a unique time interval of the audio channel so that the no audio of the audio segment is included in another audio segment) or overlapping (e.g., each audio segment may include a portion of audio that is included in a previous or subsequent audio sample).

The sampling rate value may be a dynamic value that is defined by the media device based on features of the unknown media segment (e.g., such frequency in which of speech or narration can be detected, intensity of speech or narration, frequency in which sound effects or music can be detected, intensity of sound effects or music, etc.), an indication that the media device changed channels or the media being presented, a time interval since the last instance in which the media being presented by the media device was identified, a processing load or network load of the media device, a processing load or network load of the computing device that will perform the automated content recognition, combinations thereof, and/or the like. For example, the sampling rate value may be increased when the frequency of speech is greater than a threshold to increase a likelihood that the speech can be used to identify the unknown media segment. The sampling rate value may be decreased once the unknown media segment is identified to reduce a processing load of the media device (and the computing device).

The media device may generate an audio cue including a representation of the audio segment. In some examples, when the media device is lacks the processing resources to process the audio segment or extract features (e.g., such as words, etc.) from the audio segment, the cue may include the audio segment as it was presented by the audio channel (e.g., in an unprocessed form). The unprocessed audio may be processed by the computing device during the automated content recognition. Alternatively, the media device may perform some preprocessing of the media segment. For example, the media device may apply one or more filters reduce or eliminate frequencies that are likely to be outside frequencies of speech. Frequencies associated with human voices are typically between 250 Hertz and 4000 Hertz. The media device may filter out frequencies of the audio segment outside of the voice frequency range of 250 Hz to 4000 Hz. The media device may expand the voice frequency range by a predetermined amount to avoid removing portions of the audio segment that may correspond to speech. Preprocessing may also include normalization of the audio segment at particular frequencies, increasing or decreasing the intensity of the audio segment at particular frequencies, combinations thereof, and/or the like to improve the portion of the audio segment corresponding to speech. The media device may also extract features such as, but not limited to, mel-frequency cepstrum coefficients, and/or the like.

In other examples, the media device may execute a speech-to-text model to extract a set of words from the audio segment. The set of words may be an ordered sequence of words (e.g., in a same order as represented in the audio segment), unordered collection of words, or partially ordered and partially unordered (e.g., including some sequences such as phrases, etc.). The generated audio cue may include the set of words and one or more of: an unprocessed representation of the audio segment, a processed representation of the audio segment, features extracted from the audio segment, and/or the like.

The speech-to-text model may be an algorithm or machine-learning model configured to identify words from the audio segment. The machine-learning model may be trained using a training dataset derived from similar media (e.g., such as advertisements, broadcast media, streaming media, etc.). The machine-learning model may output the set of words a long with a confidence value associated with each word and/or the set of words. The confidence value may correspond to a degree in which the output corresponds to the internal weights of the machine-learning model.

The media device may transmit the audio cue to the computing device. The computing device may be configured to identify the unknown media segment being presented by the media device using the audio cue. If the audio cue includes a representation of the audio segment (e.g., unprocessed or processed), the computing device may execute a speech-to-text model to generate a parallel set of words. The computing device may compare the parallel set of words with the set of words of the audio cue to determine an accuracy of the set of words of the audio cue. The computing device may transmit a communication to the media device with the parallel set of words. The media device may execute a reinforcement training iteration, a retraining iteration, and/or an update iteration using the parallel set of words to improve the accuracy of the machine-learning model.

The computing device may use the set of words to identify a matching reference audio cue. The computing device may include a known media database storing reference audio cues. Each reference audio cue may include a set of words and an identifier of a known media segment (e.g., such as a title, serial number, filename, etc.). Alternatively, each reference audio cue may include a set of words and an identifier of a channel that is presenting a known media segment that corresponds to the set of words. The computing device may use an exact match algorithm, a closest match algorithm, or an approximate string matching algorithm to identify the matching reference audio cue. The computing device may assign the identifier of the known media segment to the unknown media segment. The computing device may also determine an offset value (e.g., timestamp corresponding to a current portion of the known media segment that is currently being presented by the media device) based on the particular words of the set of words of the audio cue. The computing device may transmit a communication to the media device with the identifier of the known media segment.

The media device may receive a response including the identification of the unknown media segment from the computing device.

The media device may present an alternative media segment in response to receiving the identification of the unknown media segment. In some instances, the alternative media segment may be presented in place of the unknown media segment. Alternatively, the alternative media segment may be presented over the unknown media segment (e.g., such as in another window, in a picture-in-picture frame, and/or the like). In other instances, the alternative media segment may be presented in place of a media segment scheduled to be presented in the future. For example, the response from the computing device may include an identifier of the unknown media segment and/or an identifier of the channel presenting the unknown media segment (from which an identification of the unknown media segment may be determined). The media device may use the identifier of the channel to determine a candidate media segment scheduled to be presented on the channel at a future time. The media device may retrieve an alternative media segment (e.g., from local memory, the computing device, a content delivery network, remote device, etc.) and replace the candidate media segment with the alternative media segment.

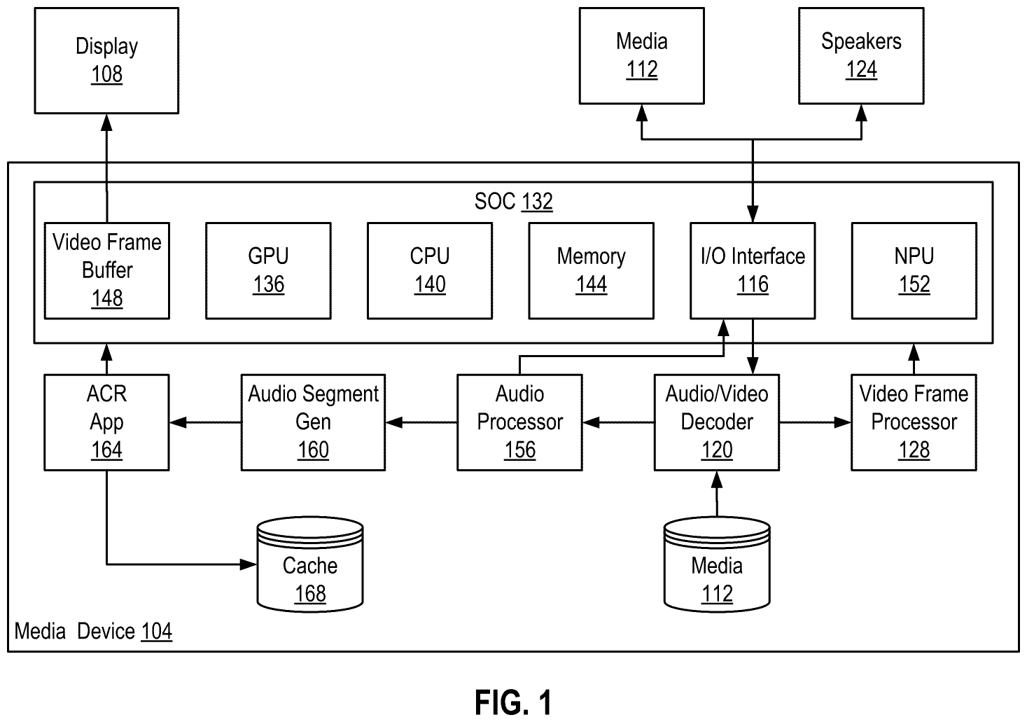

FIG. 1 illustrates a block diagram of an example media device configured to process an audio channel of media automated content recognition according to aspects of the present disclosure. Media device 104 may include one or processing components (e.g., system-on-a-chip, central processing units, application-specific integrated circuits, field programmable gate arrays, and/or the like), memories (e.g., volatile and non-volatile memories, databases, etc.), network processors (e.g., including Wi-Fi transceivers, Bluetooth transceivers, and/or other transceivers, etc.), and one or more sensors (e.g., cameras, microphones, optical sensors, etc.).

Media device 104 may be configured to present media to one or more users using display 108 and/or one or more wireless devices connected via a network processor (e.g., such as other media devices, mobile devices, tablets, and/or the like). Media device 104 may receive media 112 from one or more tuners (e.g., such as a television tuner, IP tuner, etc.), one or more external devices (e.g., such as a cable box, streaming service, etc.) through I/O interface 116 and/or through a network interface of media device 104, local memory, and/or the like. The media may be loaded by a media player, which may process the media based on the container of the video (e.g., MPEG-4, QuickTime Movie, Wavefile Audio File Format, Audio Video Interleave, etc.). The media player may pass the media to audio/video decoder 120, which decodes the video into a sequence of video frames that can be displayed by display 108 and audio into an audio stream that can be presented via one or more speakers such as speakers 124. The sequence of video frames may be passed to video frame processor 128 in preparation for display. Alternatively, media may be generated by an interactive service operating within an app manager (e.g., executing and/or managing a streaming service application, an interactive service, a media player application for local media, etc.). The app manager may pass the sequence of frames to video frame processor 140.

The sequence of video frames may be passed to system-on-a-chip (SOC) 132. SOC 132 may include processing components configured to enable the presentation of the sequence of video components and/or audio components. SOC 132 may include central processing unit (CPU) 140, graphics processing unit (GPU) 136, memory 144 (e.g., volatile memories such as random-access memory or read-only memory, non-volatile memory (e.g., such as magnetic, flash, etc.), input/output interfaces 116, video frame buffer 148, and one or more neural processing units 152 (e.g., a hardware accelerator for artificial intelligence and/or machine-learning processes). The sequence of video frames may be processed by CPU 140 and/or GPU 136 to modify a resolution one or more video frames, define a frame rate for the sequence of video frames, apply color correction and/or other color adjustments to one or more video frames, generate new video frames (e.g., interpolation, extrapolation, combinations thereof, and/or the like), modify one or more video frames to correct artifacts or other visual anomalies, combinations thereof, and/or the like. The processed sequence of video frames may be passed to video frame buffer 148. Video frame buffer 148 may be a first-in-first-out buffer configured to temporarily store the processed sequence of video frames for presentation by display 108.

Audio/video decoder 120 may decode an audio channel of media 112 to an audio stream. The audio stream may be passed to audio processor 156. Audio processor 156 may preprocess the audio stream before passing the preprocessed audio stream to speakers 124 (via I/O interface 116). Preprocessing the audio stream may include applying one or more filters, frequency modulation, interpolation and/or extrapolation, and/or the like. Audio processor 156 may also pass the audio stream (e.g., the preprocessed audio stream and/or an unprocessed audio stream) to audio segment gen 160. Audio segment gen 160 may isolate audio segments from the audio stream. The audio segments may be of a particular length (e.g., such as 5 seconds, 10 seconds, etc.), a variable length (e.g., where low intensity audio or audio with frequencies that are outside of speech, etc. may be of a longer length so as to increase a likelihood of including speech and where high intensity audio or audio with frequencies that correspond to speech may be shorter as it is likely to include speech), and/or the like. In some instances, audio segment gen 160 may isolate audio segments from every portion of the audio stream. In other instances, audio segment gen 160 may not isolate audio segments from portions of the audio stream that are unlikely to include speech (e.g., such as particular frequency ranges that likely include speech, etc.) to reduce a processing load of media device 104. The audio segments may be passed to ACR app 164.

ACR app 164 may include one or more speech-to-text models (e.g., as processes and/or machine-learning models) configured to identify a sequence of words from audio segments. The one or more speech-to-text model may use the processing resources of SOC 132 to execute. If the one or more speech-to-text models include machine-learning models, the SOC 132 may allocate one or more NPUs 152 to the machine-learning processes to increase the rate in which the machine-learning models may generate an output. The ACR app 164 may store the sequence of words extracted from an audio segment in cache 168 for temporary storage and further processing. The sequence of words extracted from the audio segment may be stored in association with the audio segment and/or the media.

In some examples, ACR app 164 may use the sequence of words extracted from the audio segment to identify the media. The sequence of words of the audio segment may be compared to words associated with known media stored in a known media database accessible to media device 104. The ACR app 164 identify a matching known media segment using an exact match algorithm which identifies matches when at least ‘n’ words of the sequence of words match within a word window of the words associated with the known media segment. The word window may be a variable length window defined as ‘m’ words of the words associated with a known media segment. The variables ‘n’ and ‘m’ may be predetermined and/or dynamically selected based on the processing state of media device 104. For instance, the ‘n’ (e.g., the minimum number of matching words to be considered a match) may be increased to reduce a likelihood of identifying multiple matches (e.g., increase an accuracy of the identification processes at the potential expense of increasing a time to identify a match) or decreased to increase a speed in which matches may be identified (e.g., at the potential expense if reduced accuracy). Similarly, the variable ‘m’ (e.g., the subsequence of words of the words associated with the known media segment that must include the n words of the sequence of words) can be increased to increase a likelihood of identifying a matching known media segment (e.g., at the potential expense of the accuracy of the identified matching known media segment) or decreased to increase an accuracy identifying a matching known media segment (e.g., at the potential expense of time needed identify a matching known media segment). In some instances, the variables ‘n’ and ‘m’ may be defined based on a content type (e.g., such movie, television show, song, podcast, advertisement, etc.), genre of the media, metadata associated with the media, and/or the like.

In some examples, the known media database accessible to media device 104 may be a partial database storing words associated with commonly presented known media to reduce memory utilization of media device 104. If ACR app 164 does not identify a matching known media segment (or if media device cannot generate the sequence of words), then ACR 164 may use an audio cue generator to generate an audio cue. The audio cue generator may generate audio cues that include the words output from the one or more speech-to-text models (e.g., if media device 104 includes the one or more speech-to-text models and media device 104 has the processing resources to execute the one or more speech-to-text models based on a current processing load value), features extracted from the audio segment, the preprocessed audio segment, the unprocessed audio segment, metadata (e.g., include characteristics of the audio segment, media device 104, the media, etc.), and/or the like. If media device 104 does not include the one or more speech-to-text models or media device lacks the processing resources to execute the one or more speech-to-text models, then the audio cue generator may generate an audio cue including features extracted from the audio segment, the preprocessed audio segment, the unprocessed audio segment, metadata (e.g., include characteristics of the audio segment, media device 104, the media, etc.), and/or the like.

ACR app 164 may transmit the audio cue to an ACR server. The ACR server may use the sequence of words to identify the media (e.g., using any of the aforementioned matching processes). The ACR server may transmit the identification of the media corresponding to the audio segment to media device 104. If the audio cue does not include the sequence of words, the ACR server may use a speech-to-text model of the ACR server to extract the sequence of words from the audio cue and search a known media database using the sequence of words. In some examples, the ACR server may transmit the sequence of words extracted by the ACR server to media device 104. ACR app 164 may compare the sequence of words extracted by the ACR server with the sequence of word extracted by ACR app 164 to determine an accuracy of the speech-to-text models, execute a reinforcement iteration for the speech-to-text models, retrain the speech-to-text models, modify the speech-to-text models, combinations thereof, and/or the like.

Media device 104 may execute one or more functions based on the identification of the media. For example, media device 104 may present an alternative media segment in place of a portion of the media or over a portion of the media. Media device 104 may retrieve one or more alternative media segments based on the identification of the media for future media substitutions (e.g., which may be triggered by a communication from the ACR server, a communication from another device, detection of a watermark in the media, and/or the like), retrieve information associated with the media (e.g., title information, character information, actor information, production information, setting information, filming information, information associated with objects and/or services presented by the media, links to webpages providing objects and/or services presented by the media, combinations thereof, and/or the like), modify a presentation of the media (e.g., present an alternative version of the media such as an on-demand version of the media, restart the media at the beginning, modify presentation settings such as audio and/or video settings, combinations thereof, and/or the like), combinations thereof, and/or the like.

The ACR server may also execute functions based on the identification of the media corresponding to the audio cue. For instance, the ACR server may store an indication that media device 104 presented the media with a timestamp corresponding to the presentation. Alternatively, or additionally, ACR server may transmit an indication that media device 104 presented the media with a timestamp corresponding to the presentation to a remote device. The ACR server or remote device may use aggregate indications of media presentation to generate audience metrics, trigger advertainment attributions, generate reports of audience metrics, and/or the like.

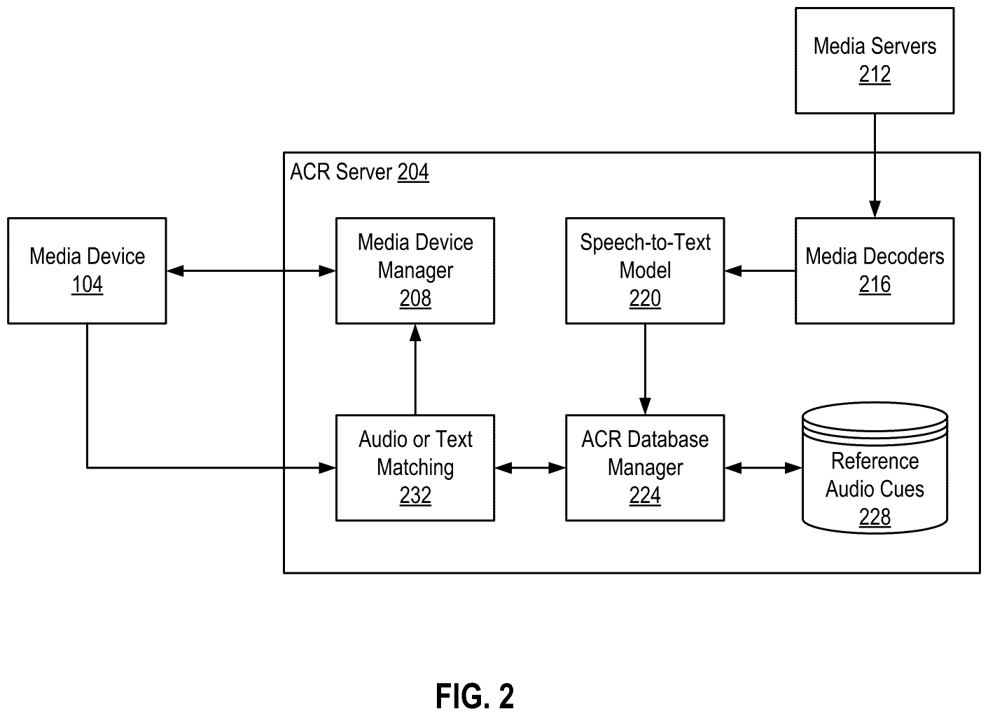

FIG. 2 illustrates a block diagram of an example ACR server configured to process an audio channel of media automated content recognition according to aspects of the present disclosure. ACR server 204 may be configured to manage operations of media devices such as media device 104 of FIG. 1. For example, ACR server 204 may include media device manager 208, which may transmit commands to media device 104 causing media device 104 to execute functions of media device 104.

In some examples, ACR server 204 may generate a database of reference audio cues that are each associated with known media segments. A media segment may include, but is not limited to a television show or portion thereof, a movie or portion thereof, a song or portion thereof, an advertisement or portion thereof, a podcast or portion thereof, audiovisual media, audio media, visual media, and/or the like. ACR server 204 may receive media from media server 212 (e.g., one or more of content servers, content delivery networks, cable networks, streaming services, the Internet, etc.). ACR server 204 may decode media using media decoders 216 into an audio stream. Media decoder 216 may include one or more audio decoders configured to decode different types of media and/or media formats. The audio streams may be passed to speech-to-text model 220 which may isolate audio segments from the audio stream and execute a speech-to-text model using the audio segments to extract words represented by the audio segments. The words may correspond to words spoken by a character or narrator, words of a song, words spoken by a presenter or host, and/or any words that can be detected over an audio channel of the media. Speech-to-text model 220 may output the words to ACR database manager 224. ACR database manager 224 may be configured to generate reference audio cues using the words extracted by speech-to-text model 220 and store the audio cues in reference audio cues 228. Each reference audio cue may include one or more of: the words extracted by speech-to-text model 220 from an audio segment, an identifier of the media corresponding to the audio segment, the audio segment, metadata associated with the media, combinations thereof, and/or the like. Once stored in reference audio cues 228, the reference audio cues may be searched to identify audio cues associated unknown media segments.

Media device 104 may transmit an audio cue associated unknown media segment that is being presented by media device 104. ACR server 204 may receive the audio cue at audio or text matching 232. If the audio cue includes a sequence of words extracted from the unknown media segment, then audio or text matching may access reference audio cues 228 to identify a reference audio cue that matches the sequence of words of the audio cue. If the audio cue does not include the sequence of words extracted from the unknown media segment, then audio or text matching 232 may pass the audio cue to speech to text model 220 and speech-to-text model 220 may extract the sequence of words using the audio cue for audio or text matching 232. Audio or text matching 232 may identify a matching known media segment using an exact match algorithm which identifies matches when at least ‘n’ words of the sequence of words match within ‘m’ words of the words of a reference audio cue. The variables ‘n’ and ‘m’ may be predetermined and/or dynamically selected based on the processing state of ACR server 204. For instance, the ‘n’ (e.g., the minimum number of matching words to be considered a match) may be increased to reduce a likelihood of identifying multiple matches (e.g., increase an accuracy of the identification processes at the potential expense of increasing a time to identify a match) or decreased to increase a speed in which matches may be identified (e.g., at the potential expense if reduced accuracy). Similarly, the variable ‘m’ (e.g., the subsequence of words of the words associated with the known media segment that must include the n words of the sequence of words) can be increased to increase a likelihood of identifying a matching known media segment (e.g., at the potential expense of the accuracy of the identified matching known media segment) or decreased to increase an accuracy identifying a matching known media segment (e.g., at the potential expense of time needed identify a matching known media segment). In some instances, the variables ‘n’ and ‘m’ may be defined based on a content type (e.g., such movie, television show, song, podcast, advertisement, etc.), genre of the media, length or size of the audio segment, metadata associated with the media, and/or the like. Alternatively, or additionally, ACR server 204 may use another matching algorithm such as, but not limited to, closest match, approximate string match, distance match, combinations thereof, and/or the like.

Audio or text matching 232 may pass the identifier associated with the matching reference audio cue to media device manager 208. Media device manager 208 may transmit a communication including the identifier to media device 104. Media device manager 208 may also include one or more commands to cause media device 104 to execute one or more operations based on the identifier. For example, the commands may cause media device 104 to present an alternative media segment in place of a portion of the media or over a portion of the media, retrieve one or more alternative media segments based on the identification of the media for future media substitutions (e.g., which may be triggered by a communication from the ACR server, a communication from another device, detection of a watermark in the media, and/or the like), retrieve information associated with the media (e.g., title information, character information, actor information, production information, setting information, filming information, information associated with objects and/or services presented by the media, links to webpages providing objects and/or services presented by the media, combinations thereof, and/or the like), modify a presentation of the media (e.g., present an alternative version of the media such as an on-demand version of the media, restart the media at the beginning, modify presentation settings such as audio and/or video settings, combinations thereof, and/or the like), combinations thereof, and/or the like. Media device manager 208 may also transmit communications to one or more other devices based on the identifier such as media attribution devices that generate audience metrics, reports, etc. based on the media particular media devices are presenting.

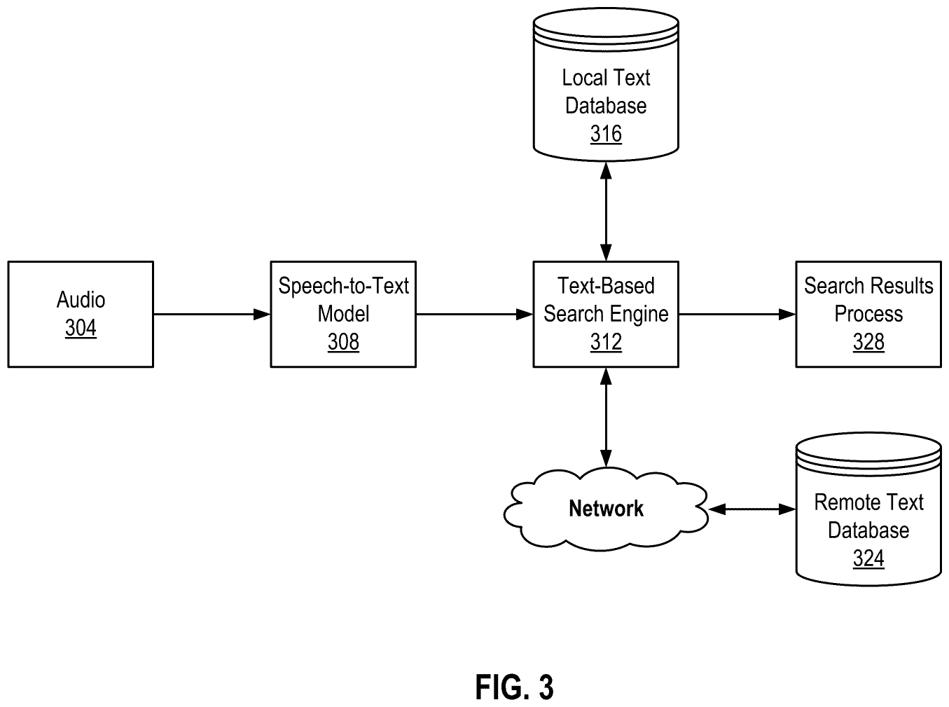

FIG. 3 illustrates a block diagram of an example automated content recognition system configured to identify media segments using an audio channel according to aspects of the present disclosure. A media device may be configured to identify media that is being presented by the media device using an audio channel of the media. The media device may be configured to process unknown audio segments and compare the unknown audio segments against a local database of known media segments. Since the media device may have limited memory, the local database of known media segments may be limited to commonly presented media, recently published media, media that likely to be presented by the media device, media previously presented by the media device, etc. The media device may access a remote database when accuracy is necessary or if no matching known media can be identified.

For example, audio stream 304 may be processed into audio segments and passed to speech-to-text model 308. The speech-to-text model may identify a sequence of words (e.g. of one or more words) represented in the audio segment. Text-based search engine 312 may receive the sequence of words and search local text database 316. Local text database 316 may store sets of words in association with known media segments. If the sequence of words (or a subsequence thereof) matches within ‘m’ words of the set of words of a particular known media segment, then text-based search engine 312 may determine that the particular known media segment matches the unknown audio cue. Text-based search engine 312 may output an identifier of particular known media segment to search results process 328. If text-based search engine 312 does not identify a matching known media segment, then text-based search engine 312 may search remote text database 324. Remote text database 324 may be stored on an ACR server (e.g., such as ACR server 204 of FIG. 2, etc.), remote device, a content delivery network, a cloud network, and/or the like. Remote text database 324 may continuously updated to include sets of words in association with a large quantity of known media segments. If a matching known media segment cannot be identified in local text database 316, a matching known media segment can be found in remote text database 324. Text-based search engine 312 may output an identifier of the matching known media segment to search results process 328.

Search results process 328 may receive one or more matching known media segment and determine which matching known media segment corresponds to the unknown audio cue. In some examples, a closest match, distance matching, and/or the like may be used to determine a difference between the unknown audio cue and each matching known media segment. Search results process 328 may then select matching known media segment that is the closest match (and/or shortest distance, least different from the unknown audio cue, etc.).

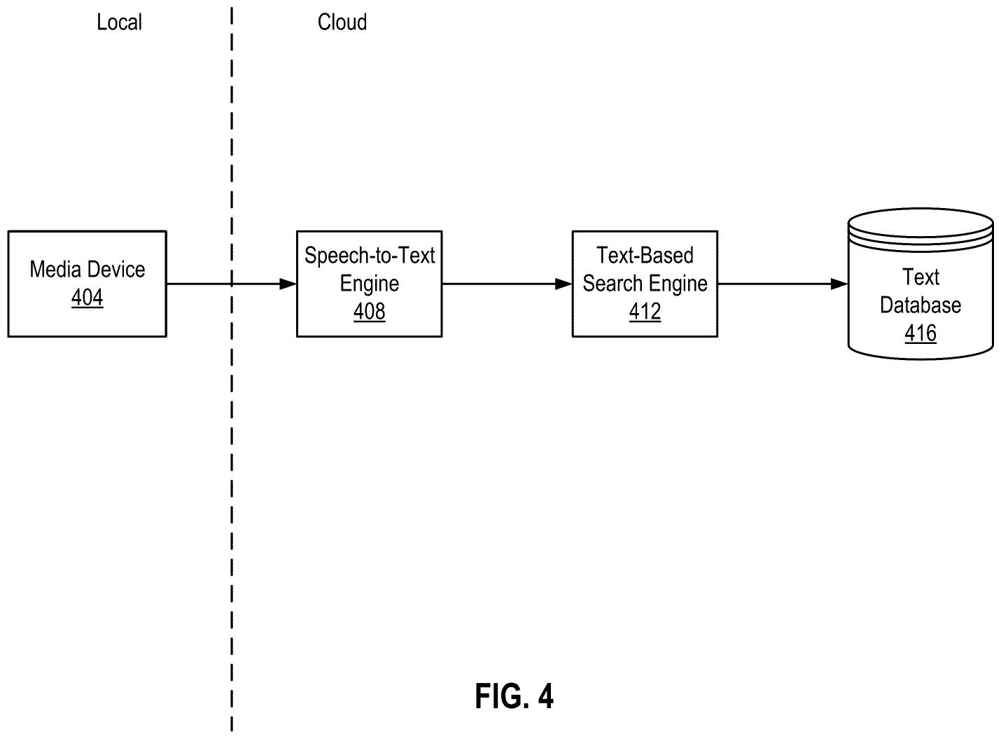

FIG. 4 illustrates a block diagram of an example automated content recognition system with cloud-based load balancing according to aspects of the present disclosure. Media device 104 may present various types of media for various sources. If the identifier of a media segment being presented is unknown (e.g., such that the media segment may be referred to as an unknown media segment), then the media device may process the audio channel and/or video channel of the unknown media segment to identify the unknown media segment. In some instances, the media device may lack the processing resources to process the audio channel and/or video channel. For instance, media device 404 may not include a speech-to-text model to process the audio channel or a current processing load of media device 404 (e.g., such as central processing unit load, memory utilization, network bandwidth, graphics processing unit load, NPU load, combinations thereof, and/or the like) may mean media device 404 does not have the resources to execute the speech-to-text model (if present). In those instances, media device 404 may offload some of the processing tasks for identifying the unknown media segment on a cloud environment (or other remote device such as an ACR server, etc.).

For example, media device may generate an audio cue from an audio segment derived from the audio channel of the unknown media segment. The audio cue may include a preprocessed representation of the audio segment, an unprocessed representation of the audio segment, metadata, and/or the like. Media device 404 may transmit the audio cue to speech-to-text model 408 operating within a cloud environment. Speech-to-text model 408 may use the processing resources of the cloud network to identify a sequence of words represented by the audio segment. The sequence of words may be passed to text-based search engine 412, which may search text database 416 for a matching reference audio cue that matches the words of the audio cue. An identifier associated with a known media segment that corresponds to the matching reference audio cue may be assigned to the audio cue.

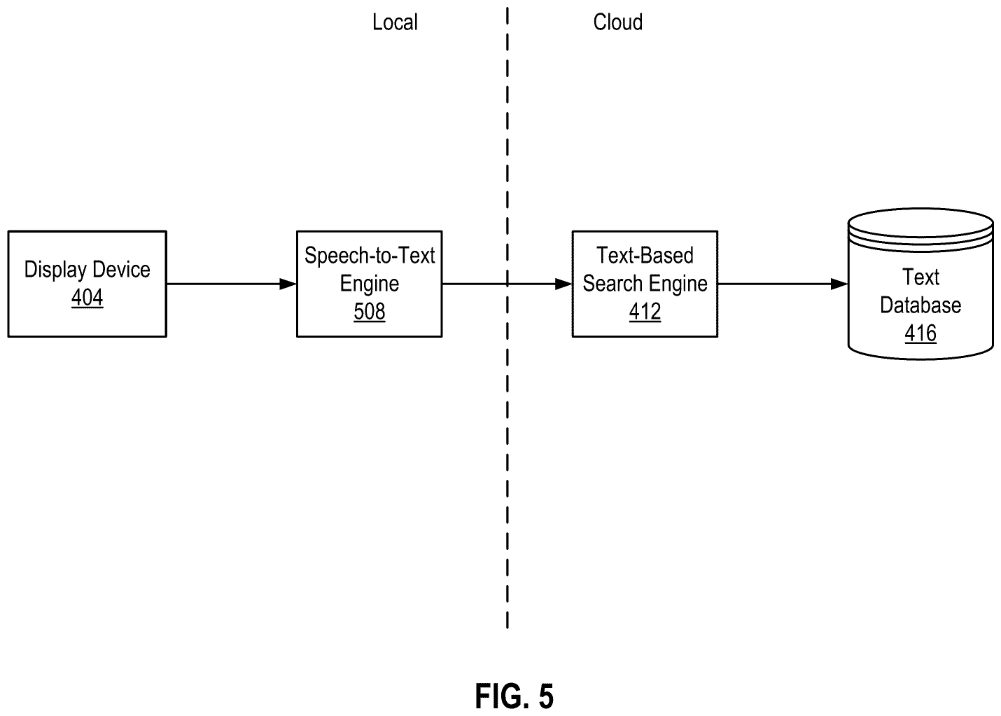

Blocks 408-416 may be executed within the cloud environment to reduce the processing load of media device 404. Media device may dynamically determine when to transmit audio cues to the cloud network. For instance, if the processing load of media device 404 is greater than the threshold, media device 404 may begin offloading some or all of blocks 408-416 onto the cloud environment until the processing load falls below the threshold. When the processing load is less than the threshold, the processing of audio segments may transition to the process diagram of FIG. 5.

FIG. 5 illustrates a block diagram of an example automated content recognition system with enhanced local processing according to aspects of the present disclosure. When the processing load of media device 404 is less than the threshold, media device 404 may localize some of the processing steps of the automated content recognition, which may decrease the processing load of the cloud environment.

For example, media device 404 may isolate an audio segment from the audio channel of the unknown media segment. Media device 404 may pass the audio segment to speech-to-text model 508 operating using processing resources of media device 404. Speech-to-text model 508 may to identify a sequence of words represented by the audio segment. Media device 404 may generate an audio cue using the sequence of words, a preprocessed representation of the audio segment, an unprocessed representation of the audio segment, metadata, and/or the like. The audio cue may be transmitted to text-based search engine 412 in the cloud environment, which may search text database 416 for a matching reference audio cue that matches the words of the audio cue. Alternatively, media device 404 may pass the audio cue to a local instances of text-based search engine 412, which may search a local text database 416 (e.g., as described in connection to FIG. 2). If the local instances of the text-base search engine 412 cannot identify a matching reference audio cue, media device 404 may transmit the audio cue to the instance of text-based search engine operating in the cloud environment. An identifier associated with a known media segment that corresponds to the matching reference audio cue may be assigned to the audio cue.

If the processing load of media device 404 become greater than the threshold and/or the processing load of the cloud network is less than a second threshold, then the automated content recognition process may return to the process of FIG. 4. The process may switch after an audio segment is identified before identifying a subsequent media segment or during any of blocks 412-416 and 508 of FIG. 5.

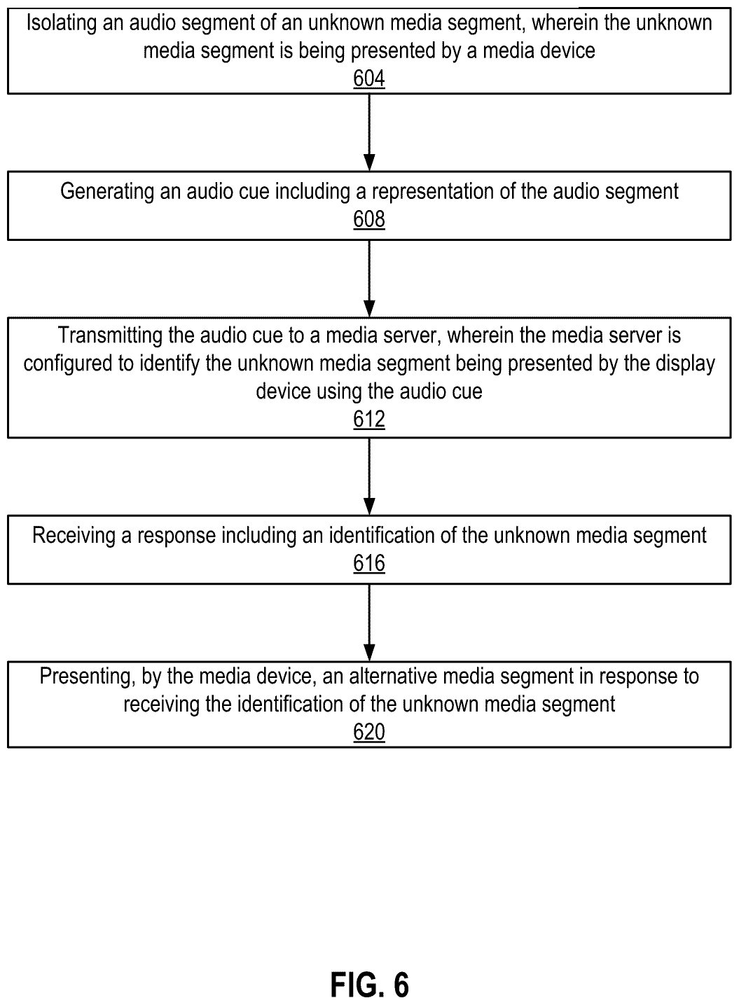

FIG. 6 illustrates a flowchart of an example process of a media device processing an audio component of media to identify a media segment of the media according to aspects of the present disclosure. At block 604, a media device may isolate an audio segment of an unknown media segment that is being presented by the media device. The audio segment may correspond to a portion of audio of an audio channel of the unknown media segment.

At block 608, the media device may generate an audio cue including a representation of the audio segment. In some examples, when the media device is lacks the processing resources to process the audio segment or extract features (e.g., such as words, etc.) from the audio segment, the cue may include the audio segment as it was presented by the audio channel (e.g., in an unprocessed form). The unprocessed audio may be processed by the computing device during the automated content recognition. Alternatively, the media device may perform some preprocessing of the media segment. For example, the media device may apply one or more filters reduce or eliminate frequencies that are likely to be outside frequencies of speech. Frequencies associated with human voices are typically between 250 Hertz and 4000 Hertz. The media device may filter out frequencies of the audio segment outside of the voice frequency range of 250 Hz to 4000 Hz. The media device may expand the voice frequency range by a predetermined amount to avoid removing portions of the audio segment that may correspond to speech. Preprocessing may also include normalization of the audio segment at particular frequencies, increasing or decreasing the intensity of the audio segment at particular frequencies, combinations thereof, and/or the like to improve the portion of the audio segment corresponding to speech. The media device may also extract features such as, but not limited to, mel-frequency cepstrum coefficients, and/or the like.

In other examples, the media device may execute a speech-to-text model to extract a set of words from the audio segment. The set of words may be an ordered sequence of words (e.g., in a same order as represented in the audio segment), unordered collection of words, or partially ordered and partially unordered (e.g., including some sequences such as phrases, etc.). The generated audio cue may include the set of words and one or more of: an unprocessed representation of the audio segment, a processed representation of the audio segment, features extracted from the audio segment, and/or the like.

The speech-to-text model may be an algorithm or machine-learning model configured to identify words from the audio segment. The machine-learning model may be trained using a training dataset derived from similar media (e.g., such as advertisements, broadcast media, streaming media, etc.). The machine-learning model may output the set of words a long with a confidence value associated with each word and/or the set of words. The confidence value may correspond to a degree in which the output corresponds to the internal weights of the machine-learning model.

At block 612, the media device may transmit the audio cue to a computing device. The computing device may be configured to identify the unknown media segment being presented by the media device using the audio cue. If the audio cue includes a representation of the audio segment (e.g., unprocessed or processed), the computing device may execute a speech-to-text model to generate a parallel set of words. The computing device may compare the parallel set of words with the set of words of the audio cue to determine an accuracy of the set of words of the audio cue. The computing device may transmit a communication to the media device with the parallel set of words. The media device may execute a reinforcement training iteration, a retraining iteration, and/or an update iteration using the parallel set of words to improve the accuracy of the machine-learning model.

The computing device may use the set of words to identify a matching reference audio cue. The computing device may include a known media database storing reference audio cues. Each reference audio cue may include a set of words and an identifier of a known media segment (e.g., such as a title, serial number, filename, etc.). Alternatively, each reference audio cue may include a set of words and an identifier of a channel that is presenting a known media segment that corresponds to the set of words. The computing device may use an exact match algorithm, a closest match algorithm, or an approximate string matching algorithm to identify the matching reference audio cue. The computing device may assign the identifier of the known media segment to the unknown media segment. The computing device may also determine an offset value (e.g., timestamp corresponding to a current portion of the known media segment that is currently being presented by the media device) based on the particular words of the set of words of the audio cue. The computing device may transmit a communication to the media device with the identifier of the known media segment.

At block 616, the media device may receive a response including the identification of the unknown media segment from the computing device.

At block 620, the media device may present an alternative media segment in response to receiving the identification of the unknown media segment. In some instances, the alternative media segment may be presented in place of the unknown media segment. Alternatively, the alternative media segment may be presented over the unknown media segment (e.g., such as in another window, in a picture-in-picture frame, and/or the like). In other instances, the alternative media segment may be presented in place of a media segment scheduled to be presented in the future. For example, the response from the computing device may include an identifier of the unknown media segment and/or an identifier of the channel presenting the unknown media segment (from which an identification of the unknown media segment may be determined). The media device may use the identifier of the channel to determine a candidate media segment scheduled to be presented on the channel at a future time. The media device may retrieve an alternative media segment (e.g., from local memory, the computing device, a content delivery network, remote device, etc.) and replace the candidate media segment with the alternative media segment.

In some examples, execute the processes of FIG. 6 more than once with each iteration being executed in series, in parallel, and/or partially in series and partially in parallel. For example, the media device may execute block 604 by sampling the audio channel according to a sampling rate value to isolate multiple audio segments. The sampling rate value may determine a quantity of samples that define from the audio channel over a time interval. In some instances, the audio segments may be non-overlapping (e.g., each audio segment is derived from a unique time interval of the audio channel so that the no audio of the audio segment is included in another audio segment) or overlapping (e.g., each audio segment may include a portion of audio that is included in a previous or subsequent audio sample).

The sampling rate value may be defined by the media device (e.g., prior to executing block 604 or while executing processes 604-620, etc.) based on features of the unknown media segment (e.g., such frequency in which of speech or narration can be detected, intensity of speech or narration, frequency in which sound effects or music can be detected, intensity of sound effects or music, etc.), an indication that the media device changed channels or the media being presented, a time interval since the last instance in which the media being presented by the media device was identified, a processing load or network load of the media device, a processing load or network load of the computing device that will perform the automated content recognition, combinations thereof, and/or the like. For example, the sampling rate value may be increased when the frequency of speech is greater than a threshold to increase a likelihood that the speech can be used to identify the unknown media segment. The sampling rate value may be decreased once the unknown media segment is identified to reduce a processing load of the media device (and the computing device).

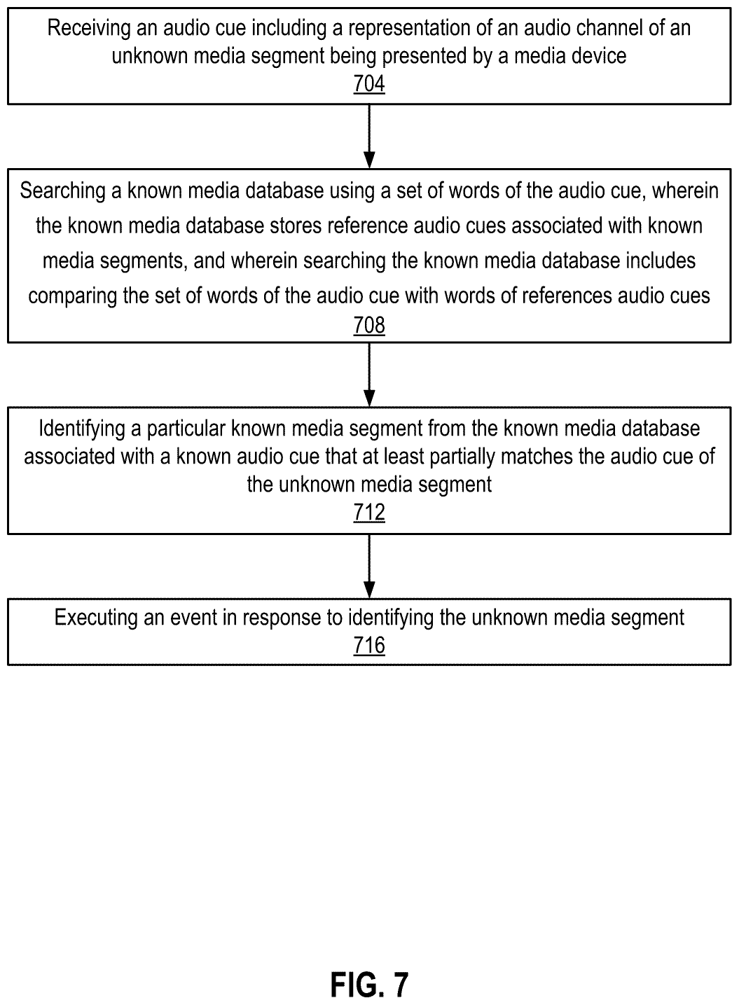

FIG. 7 illustrates a flowchart of an example process of a automate content recognition system configured to process audio cues to identify media segments and manage media device based on identified media segments according to aspects of the present disclosure. At block 704, an ACR server may receive an audio cue including features derived from an audio channel of an unknown media segment being presented by a media device (e.g., a television, display device, computing device, media player, etc.). The media segment may include an audio segment (e.g., from an audio channel of the media) that includes a representation of words (e.g., such as, but not limited to, one or more characters speaking, a song, a narrator, etc.).

In some examples, the features of the audio cue may include a set of words extracted from the audio channel of the unknown media segment. For instance, the media device may include a speech-to-text model that may identify words within the audio channel, extract words from a data channel of the unknown media segment (e.g., such as subtitles, closed captions, etc.), and/or the like. Alternatively, the media device may transmit an audio segment to a remote device and the remote device may return an identification of the set of words represented in the audio segment. The set of words may be stored in an ordered sequence or as an unordered collection. The media device may generate the audio cue and transmit the audio cue to the ACR server to identify the media.

In other examples, the media device may be unable to process the audio channel to extract the set of words. For instance, the media device may lack the processing resources, be under a heavy processing load, etc. In those examples, the features of the audio cue may include a representation of an audio segment of the audio channel (e.g., processed or unprocessed audio). The representation of the audio segment may be the same as the audio segment received by the media device. Alternatively, the audio segment may be processed to reduce network resources of the media device. For instance, the audio sample may be down sampled, filtered, converted into a different domain such as a frequency domain, combinations thereof, and/or the like to reduce the size of the audio cue transmitted to the ACR server. The ACR server may extract the words from the audio segment using a speech-to-text model. The speech-to-text model may be similar to the speech-to-text model utilized by the media device (e.g., of a same type, trained using similar or the same data, etc.). Alternatively, the ACR server may transmit the audio cue to a remote device configured to identify the set of words. The remote device may process the audio cue and return an identification of the set of words to the ACR server.

At block 708, the ACR server may search a known media database using the set of words of the audio cue. The known media database may store reference audio cues associated with known media segments. Each reference audio cue may include one or more sets of words extracted from the known media segment and an identifier of the known media segment. The one or more sets of words may include sequences of words and/or collections of words (e.g., unordered). The ACR server may compare the set of words and/or one or more subsets of the set of words to the words of the reference audio cues of the known media database. In some instances, the ACR server may use an exact match algorithm to identify reference audio cues that exactly match a predetermined quantity of words of the audio cue. For instance, the ACR server may identify reference audio cues that include the set of words in the same order. Alternatively, the ACR server may identify reference audio cues that include at least a particular subset of the set of words. The ACR server may determine a minimum quantity of words that must be included within a predetermined quantity of words of a reference audio cue for the reference audio cue to be considered a match to the audio cue of the unknown media segment. The minimum quantity of words may be selected to increase the accuracy of searching the known media database (e.g., by increasing the minimum quantity of words that must match) and/or to increase the speed in which matches may be identified (e.g., by decreasing the minimum quantity of words that must match). The minimum quantity of words may be selected before execution of the blocks of FIG. 7 or at runtime during execution of any of blocks 704-716.

In other instances, the ACR server may use a closest match algorithm when searching the known media database. The closest match algorithm may identify one or more reference audio cues of the known media database that include words that match the set of words of the unknown media segment in the same general order. The closest match algorithm may then assign a score to each of the one or more reference audio cues based on a degree in which the reference audio cue matches the set of words in a same order. The ACR server may select the reference audio cue assigned the highest score as the reference audio cue that is a closest match to the audio cue.

The closest match algorithm may identify a matching reference audio cue even when the complete sequence of words of the set of words of the unknown media segment is not included in the reference audio cue. For example, the audio cue may be missing one or more words due to errors, poor speech-to-text translations, data corruption, etc. The closest match algorithm may use a scoring system to enable identify reference audio cues that match even when the audio cue may not be accurate or may be incomplete. The closest match algorithm may assign score based on the quantity of the reference audio cue that match the audio cue in the same order. The closest match algorithm may lower the score for each intervening words (e.g., words of the reference audio cue positioned between words the audio cue and not included in the audio cue). For example, the audio cue may include the word sequence “the quick brown fox over the lazy dog”. The candidate reference audio cue “the quick brown fox jumps over the lazy dog” may include all of the words of the audio cue in the same order but includes the intervening word “jump”. The closest match algorithm may assign “1” for each matching word in the correct order and subtract 0.5 for each intervening word causing the candidate reference audio to be assigned a score of 7.5. If the closest match algorithm may does not assign another reference audio cue with a higher score, then the candidate reference audio may be considered a match for the audio cue.

In still yet other instances, the ACR server may use an approximate string matching algorithm (e.g., such as a fuzzy string search, etc.). Approximate string matching algorithms may identify strings (e.g., one or more words, phrases, sentences, etc.) that are an approximate match to the set of words of the unknown media segment. For example, approximate string matching algorithms may identify the word “jumps” from an input of “jump” even though the input word does not exactly match the identified word. Approximate string matching algorithms may reduce a likelihood of errors (e.g., caused by the speech-to-text model, transmission, etc.) from impacting the ability of the ACR server to identify a matching reference audio cue.

Other matching algorithms may be used in addition to or in place of exact match, closest match, and/or an approximate string matching such as, but not limited to a distance search, interpolation searching, etc.

In some examples, the ACR server may dynamically switch between exact match, closest match, and approximate string matching algorithms based on a current state of the ACR server and/or the media device requesting automated content recognition services. For example, the ACR server may default to an exact match and switch to closest match or approximate string matching algorithms upon determining that the exact match has timed out (e.g., takes too long to identify a matching reference audio cue or cannot identify a reference audio cue, etc.) or when a processing load of the ACR server is greater than a threshold load value.

At block 712, the ACR server may identify a particular reference audio cue that matches the audio cue. The ACR server may assign an identifier of the known media segment associated with the particular reference audio cue to the unknown media segment.

At block 716, the ACR server may execute an event in response to identifying the particular reference audio cue that matches the audio cue. In some instances, the event may include transmitting a communication to the media device. The communication may include a command that, when executed by the media device, causes the media device to perform one or more operations such as, but not limited to, presenting an alternative media segment in place of the (now) known media segment being presented by the media device, presenting an alternative media segment in place of a future media segment that is scheduled to be presented by the media device, present additional information associated with the (now) known media segment being presented by the media device, presenting information associated with an object or service depicted in the (now) known media segment being presented the media device (e.g., via a web browser or application of the media device), facilitating a presentation of any of the aforementioned media and/or information on another device associated with the media device (e.g., such as a mobile device, tablet, ACR server, etc. in communication with the media device), combinations thereof, and/or the like. Alternatively, or additionally, the event may include transmitting a communication to another remote device to cause a watermark to be embedded into a media being presented by the media device (e.g., such as a watermark, etc.) configured to cause the media device to execute one or more functions, report an identification of the unknown media segment, request media that is contextually related to the (now) known media segment, combinations thereof, and/or the like.

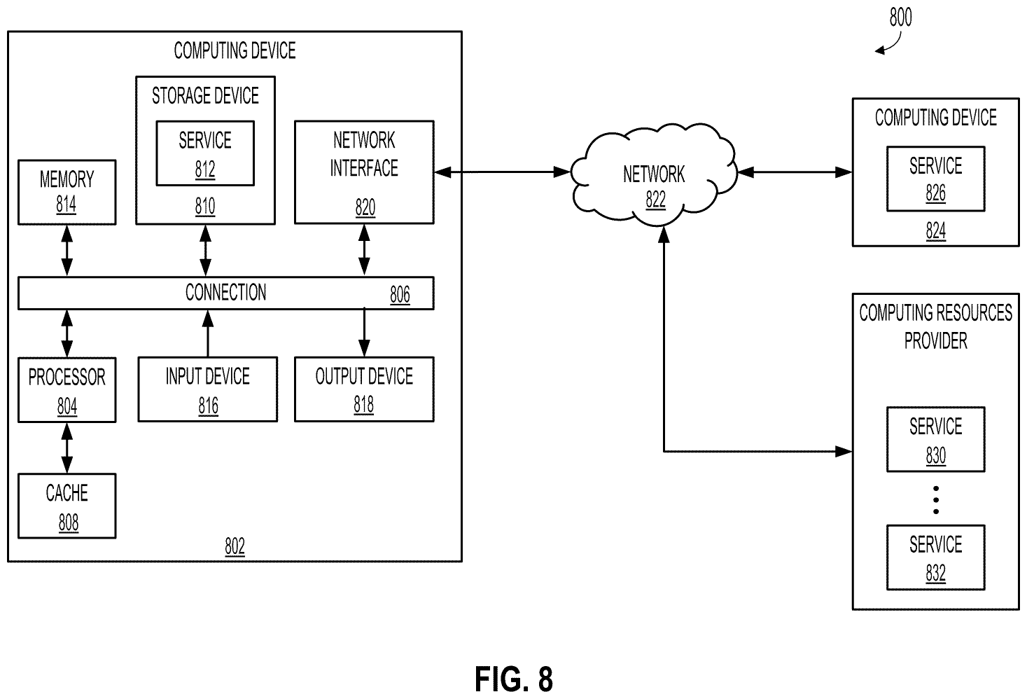

FIG. 8 illustrates an example computing device architecture of an example computing device that can implement the various techniques described herein according to aspects of the present disclosure. The example computing system architecture 800 illustrated in FIG. 8 includes a computing device 802, which has various components in electrical communication with each other using a connection 806, such as a bus, in accordance with some implementations. The example computing system architecture 800 includes a processing unit 804 that is in electrical communication with various system components, using the connection 806, and including the system memory 814. In some embodiments, the system memory 814 includes read-only memory (ROM), random-access memory (RAM), and other such memory technologies including, but not limited to, those described herein. In some embodiments, the example computing system architecture 800 includes a cache 808 of high-speed memory connected directly with, in close proximity to, or integrated as part of the processor 804. The system architecture 800 can copy data from the memory 814 and/or the storage device 810 to the cache 808 for quick access by the processor 804. In this way, the cache 808 can provide a performance boost that decreases or eliminates processor delays in the processor 804 due to waiting for data. Using modules, methods and services such as those described herein, the processor 804 can be configured to perform various actions. In some embodiments, the cache 808 may include multiple types of cache including, for example, level one (L1) and level two (L2) cache. The memory 814 may be referred to herein as system memory or computer system memory. The memory 814 may include, at various times, elements of an operating system, one or more applications, data associated with the operating system or the one or more applications, or other such data associated with the computing device 802.

Other system memory 814 can be available for use as well. The memory 814 can include multiple different types of memory with different performance characteristics. The processor 804 can include any general-purpose processor and one or more hardware or software services, such as service 812 stored in storage device 810, configured to control the processor 804 as well as a special-purpose processor where software instructions are incorporated into the actual processor design. The processor 804 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 804 can be a microprocessor, a microcontroller, a digital signal processor (“DSP”), or a combination of these and/or other types of processors. In some embodiments, the processor 804 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 800, an input device 816 can represent any number of input mechanisms, such as a microphone for speech, a touch-sensitive screen for gesture or graphical input, keyboard, mouse, motion input, pen, and other such input devices. An output device 818 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 800. In some embodiments, the input device 816 and/or the output device 818 can be coupled to the computing device 802 using a remote connection device such as, for example, a communication interface such as the network interface 820 described herein. In such embodiments, the communication interface can govern and manage the input and output received from the attached input device 816 and/or output device 818. As may be contemplated, there is no restriction on operating on any particular hardware arrangement and accordingly the basic features here may easily be substituted for other hardware, software, or firmware arrangements as they are developed.

In some embodiments, the storage device 810 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 810 can include hardware and/or software services such as service 812 that can control or configure the processor 804 to perform one or more functions including, but not limited to, the methods, processes, functions, systems, and services described herein in various embodiments. In some embodiments, the hardware or software services can be implemented as modules. As illustrated in example computing system architecture 800, the storage device 810 can be connected to other parts of the computing device 802 using the system connection 806. In some embodiments, a hardware service or hardware module such as service 812, that performs a function can include a software component stored in a non-transitory computer-readable medium that, in connection with the necessary hardware components, such as the processor 804, connection 806, cache 808, storage device 810, memory 814, input device 816, output device 818, and so forth, can carry out the functions such as those described herein.

The disclosed systems and services can be performed using a computing system such as the example computing system illustrated in FIG. 8, using one or more components of the example computing system architecture 800. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor can be configured to carry out some or all of methods and systems described in connection with the media device described herein by, for example, executing code using a processor such as processor 804 wherein the code is stored in memory such as memory 814 as described herein. One or more of a user device, a provider server or system, a database system, or other such devices, services, or systems may include some or all of the components of the computing system such as the example computing system illustrated in FIG. 8, using one or more components of the example computing system architecture 800 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 828. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 804 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 814 can be coupled to the processor 804 by, for example, a connector such as connector 806, or a bus. As used herein, a connector or bus such as connector 806 is a communications system that transfers data between components within the computing device 802 and may, in some embodiments, be used to transfer data between computing devices. The connector 806 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 814 can include RAM including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 814 can also include magnetic or optical data storage media including read-only (e.g., CD ROM and DVD ROM) or otherwise (e.g., CD or DVD). The memory can be local, remote, or distributed.

As described above, the connector 806 (or bus) can also couple the processor 804 to the storage device 810, which may include non-volatile memory or storage, a drive unit, and/or the like. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 810. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 806 can also couple the processor 804 to a network interface device such as the network interface 820. The interface can include one or more of a modem or other such network interfaces including, but not limited to those described herein. It will be appreciated that the network interface 820 may be considered to be part of the computing device 802 or may be separate from the computing device 802. The network interface 820 can include one or more of an analog modem, Integrated Services Digital Network (ISDN) modem, cable modem, token ring interface, satellite transmission interface, or other interfaces for coupling a computer system to other computer systems. In some embodiments, the network interface 820 can include one or more input and/or output (I/O) devices. The I/OFIG devices can include, by way of example but not limitation, input devices such as input device 816 and/or output devices such as output device 818. For example, the network interface 820 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 8 Mobile®, the Blackberry® OS, etc.), and real-time operating systems (e.g., VxWorks®, QNX®, cCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 802 can be connected to one or more additional computing devices such as computing device 824 via a network 822 using a connection such as the network interface 820. In such embodiments, the computing device 824 may execute one or more services 826 to perform one or more functions under the control of, or on behalf of, programs and/or services operating on computing device 802. In some embodiments, a computing device such as computing device 824 may include one or more of the types of components as described in connection with computing device 802 including, but not limited to, a processor such as processor 804, a connection such as connection 806, a cache such as cache 808, a storage device such as storage device 810, memory such as memory 814, an input device such as input device 816, and an output device such as output device 818. In such embodiments, the computing device 824 can carry out the functions such as those described herein in connection with computing device 802. In some embodiments, the computing device 802 can be connected to a plurality of computing devices such as computing device 824, each of which may also be connected to a plurality of computing devices such as computing device 824. Such an embodiment may be referred to herein as a distributed computing environment.

The network 822 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 822 can be wired connections, wireless connections, or combinations thereof. Communications via the network 822 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 822, within the computing device 802, within the computing device 824, or within the computing resources provider 828 can include information, which also may be referred to herein as content. The information may include text, graphics, audio, video, haptics, and/or any other information that can be provided to a user of the computing device such as the computing device 802. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 802 and presented to a user of the computing device 802 using forms that are perceptible via sight, sound, smell, taste, touch, or other such mechanisms. In some embodiments, communications over the network 822 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 802 and/or the computing device 824 can be connected to a computing resources provider 828 via the network 822 using a network interface such as those described herein (e.g., network interface 820). In such embodiments, one or more systems (e.g., service 830 and service 832) hosted within the computing resources provider 828 (also referred to herein as within “a computing resources provider environment”) may execute one or more services to perform one or more functions under the control of, or on behalf of, programs and/or services operating on computing device 802 and/or computing device 824. Systems such as service 830 and service 832 may include one or more computing devices such as those described herein to execute computer code to perform the one or more functions under the control of, or on behalf of, programs and/or services operating on computing device 802 and/or computing device 824.

For example, the computing resources provider 828 may provide a service, operating on service 830 to store data for the computing device 802 when, for example, the amount of data that the computing device 802 exceeds the capacity of storage device 810. In another example, the computing resources provider 828 may provide a service to first instantiate a virtual machine (VM) on service 832, use that VM to access the data stored on service 832, perform one or more operations on that data, and provide a result of those one or more operations to the computing device 802. Such operations (e.g., data storage and VM instantiation) may be referred to herein as operating “in the cloud,” “within a cloud computing environment,” or “within a hosted virtual machine environment,” and the computing resources provider 828 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 828 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, combinations thereof, or the like. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 830 and service 832 may implement versions of various services (e.g., the service 812 or the service 826) on behalf of, or under the control of, computing device 802 and/or computing device 824. Such implemented versions of various services may involve one or more virtualization techniques so that, for example, it may appear to a user of computing device 802 that the service 812 is executing on the computing device 802 when the service is executing on, for example, service 830. As may also be contemplated, the various services operating within the computing resources provider 828 environment may be distributed among various systems within the environment as well as partially distributed onto computing device 824 and/or computing device 802.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a computer-implemented method comprising: receiving an audio cue including a representation of an audio channel of an unknown media segment being presented by a display device; searching a known media database using a set of words of the audio cue, wherein the known media database stores reference audio cues associated with known media segments, and wherein searching the known media database includes comparing the set of words of the audio cue with words of reference audio cues; identifying a particular known media segment from the known media database associated with a reference audio cue that at least partially matches the audio cue of the unknown media segment; and executing an event in response to identifying the unknown media segment.

Example 2 is the computer-implemented method of any of example(s) 1 and 3-7, further comprising: extracting, from the audio cue, the set of words using a speech-to-text machine-learning model.

Example 3 is the computer-implemented method of any of example(s) 1-2 and 4-7, wherein the audio cue includes the set of words.

Example 4 is the computer-implemented method of any of example(s) 1-3 and 5-7, wherein the set of words is ordered.

Example 5 is the computer-implemented method of any of example(s) 1-4 and 5-7, wherein identifying the particular known media segment from the known media database includes: defining a word window comprising a sequence of words of the reference audio cue; and matching one or more of the set of words of the audio cue to one or more words of the sequence of words of the reference audio cue.

Example 6 is the computer-implemented method of any of example(s) 1-5 and 7, wherein executing the event includes: facilitating a transmission of a command to the display device, the command, when received, causes the display device to present an alternative media segment in place of the unknown media segment.

Example 7 is the computer-implemented method of any of example(s) 1-6, wherein identifying the particular known media segment from the known media database includes: transmitting a communication to a device associated with the unknown media segment, wherein the communication includes an indication that the unknown media segment is being displayed.

Example 8 is a computer-implemented method comprising: isolating an audio segment of an unknown media segment, wherein the unknown media segment is being presented by a display device; generating an audio cue including a representation of the audio segment; transmitting the audio cue to a media server, wherein the media server is configured to identify the unknown media segment being presented by the display device using the audio cue; receiving a response including an identification of the unknown media segment; and presenting, by the display device, an alternative media segment in response to receiving the identification of the unknown media segment.

Example 9 is the computer-implemented method of any of example(s) 8 and 10-15, wherein generating the audio cue includes: extracting a set of words from the audio segment using a speech-to-text machine-learning model of the display device, wherein the representation of the audio segment includes the set of words.

Example 10 is the computer-implemented method of any of example(s) 8-9 and 11-15, wherein the set of words are ordered based on a location of the audio segment from which each word of the set of words is extracted.

Example 11 is the computer-implemented method of any of example(s) 8-10 and 12-15, wherein the representation of the audio segment is in a frequency domain.

Example 12 is the computer-implemented method of any of example(s) 8-11 and 13-15, wherein the alternative media segment is selected based on the identification of the unknown media segment.

Example 13 is the computer-implemented method of any of example(s) 8-12 and 14-15, wherein the alternative media segment is selected based on the identification of the display device.

Example 14 is the computer-implemented method of any of example(s) 8-13 and 15, wherein the response includes an identification of the alternative media segment.

Example 15 is the computer-implemented method of any of example(s) 8-14, further comprising: transmitting a request for the alternative media segment.

Example 16 is a system comprising: one or more processors; a non-transitory computer-readable medium storing instructions that when executed by the one or more processors, cause the one or more processors to perform the methods of any of example(s)s 1-15.

Example 17 is a non-transitory computer-readable medium storing instructions that when executed by one or more processors, cause the one or more processors to perform the methods of any of example(s)s 1-15.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process of FIG. 6-7). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112 (f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A computer-implemented method comprising:
receiving an audio cue including a representation of an audio channel of an unknown media segment being presented by a media device;
searching a known media database using a set of words of the audio cue, wherein the known media database stores reference audio cues associated with known media segments, and wherein searching the known media database includes comparing the set of words of the audio cue with words of reference audio cues;
identifying a particular known media segment from the known media database associated with a reference audio cue that at least partially matches the audio cue of the unknown media segment; and
executing an event in response to identifying the unknown media segment.

2. The computer-implemented method of claim 1, further comprising:
extracting, from the audio cue, the set of words using a speech-to-text machine-learning model.

3. The computer-implemented method of claim 1, wherein the audio cue includes the set of words.

4. The computer-implemented method of claim 1, wherein the set of words is ordered.

5. The computer-implemented method of claim 1, wherein identifying the particular known media segment from the known media database includes:
defining a word window comprising a sequence of words of the reference audio cue; and
matching one or more of the set of words of the audio cue to one or more words of the sequence of words of the reference audio cue.

6. The computer-implemented method of claim 1, wherein executing the event includes:
facilitating a transmission of a command to the media device, the command, when received, causes the media device to present an alternative media segment in place of the unknown media segment.

7. The computer-implemented method of claim 1, wherein identifying the particular known media segment from the known media database includes:
transmitting a communication to a device associated with the unknown media segment, wherein the communication includes an indication that the unknown media segment is being displayed.

8. A system comprising:
one or more processors; and
a non-transitory computer readable medium storing instructions that when executed by the one or more processors, cause the one or more processors to perform operations including:
receiving an audio cue including a representation of an audio channel of an unknown media segment being presented by a media device;
searching a known media database using a set of words of the audio cue, wherein the known media database stores reference audio cues associated with known media segments, and wherein searching the known media database includes comparing the set of words of the audio cue with words of reference audio cues;
identifying a particular known media segment from the known media database associated with a reference audio cue that at least partially matches the audio cue of the unknown media segment; and
executing an event in response to identifying the unknown media segment.

9. The system of claim 8, further comprising:
extracting, from the audio cue, the set of words using a speech-to-text machine-learning model.

10. The system of claim 8, wherein the audio cue includes the set of words.

11. The system of claim 8, wherein the set of words is ordered.

12. The system of claim 8, wherein identifying the particular known media segment from the known media database includes:
defining a word window comprising a sequence of words of the reference audio cue; and
matching one or more of the set of words of the audio cue to one or more words of the sequence of words of the reference audio cue.

13. The system of claim 8, wherein executing the event includes:
facilitating a transmission of a command to the media device, the command, when received, causes the media device to present an alternative media segment in place of the unknown media segment.

14. The system of claim 8, wherein identifying the particular known media segment from the known media database includes:
transmitting a communication to a device associated with the unknown media segment, wherein the communication includes an indication that the unknown media segment is being displayed.

15. A non-transitory computer readable medium storing instructions that when executed by one or more processors, cause the one or more processors to perform operations including:
receiving an audio cue including a representation of an audio channel of an unknown media segment being presented by a media device;
searching a known media database using a set of words of the audio cue, wherein the known media database stores reference audio cues associated with known media segments, and wherein searching the known media database includes comparing the set of words of the audio cue with words of reference audio cues;
identifying a particular known media segment from the known media database associated with a reference audio cue that at least partially matches the audio cue of the unknown media segment; and
executing an event in response to identifying the unknown media segment.

16. The non-transitory computer readable medium of claim 15, further comprising:
extracting, from the audio cue, the set of words using a speech-to-text machine-learning model.

17. The non-transitory computer readable medium of claim 15, wherein the audio cue includes the set of words.

18. The non-transitory computer readable medium of claim 15, wherein identifying the particular known media segment from the known media database includes:
defining a word window comprising a sequence of words of the reference audio cue; and
matching one or more of the set of words of the audio cue to one or more words of the sequence of words of the reference audio cue.

19. The non-transitory computer readable medium of claim 15, wherein executing the event includes:
facilitating a transmission of a command to the media device, the command, when received, causes the media device to present an alternative media segment in place of the unknown media segment.

20. The non-transitory computer readable medium of claim 15, wherein identifying the particular known media segment from the known media database includes:
transmitting a communication to a device associated with the unknown media segment, wherein the communication includes an indication that the unknown media segment is being displayed.
